(19) United States
(12) Patent Application Publication
(10) Pub. No.: US 2004/0226220 A1
(43) Pub. Date: Nov. 18, 2004

(54) Coupling structure for side bracket of door/window venetian blind

(75) Inventor: Pey Son Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: CHING FENG BLINDS IND. CO., LTD.

(21) Appl. No.: 10/436,195

(22) Filed: May 13, 2003

(51) Int. Cl. E06B 7/08

(52) U.S. Cl. 49/74.1

(57) ABSTRACT

A coupling structure for side bracket of door/window Venetian blind is mainly made up of a Venetian door/window unit, and a coupling board pivotally joined to one side of the Venetian door/window unit wherein the other side of the coupling board having a plurality of stepwise through holes equidistantly disposed thereon is securely fixed to an inner wall of a preset frame via screws. A flat elastic plate made of either plastic or soft foam materials is sandwiched between the coupling board and the inner wall of the preset frame. When the coupling board is screw joined to the inner wall thereof, the flat elastic plate clamped tight there-between will abut closely against the inner wall to fill up any fissures in case of rough surface on the inner wall thereof without any other silicon filling materials required, effectively sheltering sun or wind from coming in there-through as well as increasing the overall beauty of the door/window Venetian thereof in display.

### BACKGROUND OF THE INVENTION

The present invention is related to a coupling structure for side bracket of door/window Venetian blind, mainly made up of a Venetian door/window unit, and a coupling board pivotally joined to one side of the Venetian door/window unit wherein the other side of the coupling board having stepwise through holes equidistantly disposed thereon is securely locked to an inner wall of a preset frame via screws. A flat elastic plate made of either plastic or soft foam materials is sandwiched between the coupling board and the inner wall of the preset frame therein. When pressed tight by the coupling board, the flat elastic plate will abut closely against the inner wall thereof, filling up any fissures in case of rough surface of the inner wall thereof without any other silicon filling materials required, effectively sheltering sun or wind from coming in there-through as well as increasing the overall beauty of the door/window Venetian thereof in display.

Please refer to FIG. 1. A conventional coupling structure for side bracket of door/window Venetian blind is mainly made up of a Venetian door/window unit 10, a coupling board 20 pivotally joined at one side of the door/window unit 10. A plurality of equally spaced stepwise through holes 21 are disposed at one side of the coupling board, via which the coupling board 20 is directly secured onto an inner wall 40 of a preset frame.

There are some drawbacks to such conventional coupling structure for side bracket of door/window Venetian blind. First, the coupling board 20 is directly fixed to the inner wall 40 of the preset frame. In case of rough surfaces on the inner wall 40 thereof, fissures A may appear between the coupling board 20 and the inner wall 40 thereof, making the Venetian door/window unit 20 thereof fail to effectively shelter sun or wind from coming in there-through. Second, the fissures A produced in case of rough surfaces of the inner wall 40 thereof may destroy the overall beauty of the door/window Venetian blind in display.

To fill up fissures A of the conventional coupling structure thereof, a layer of fastening agent is first applied onto the inner wall 40 thereof before the coupling board 20 is attached to the inner wall 40 and fixed thereto via screws 30. In case of a thin layer of fastening agent, fissures A may be insufficiently filled up. Yet, when a large amount of fastening agent is applied thereon, it not only uneconomically boosts the costs of materials and production, but also easily destroys the overall beauty of the door/window Venetian blind in display since the fastening agent might easily be applied onto the outer wall of the preset frame thereof.

### SUMMARY OF THE PRESENT INVENTION

It is, therefore, the primary purpose of the present invention to provide a coupling structure for side bracket of door/window Venetian blind, mainly made up of a Venetian door/window unit, and a coupling board pivotally joined to one side of the Venetian door/window unit wherein the other side of the coupling board is securely locked to an inner wall of a preset frame with a flat elastic plate sandwiched there-between. When pressed tight by the coupling board, the flat elastic plate will abut closely against the inner wall thereof to fill up any fissures between the coupling board and the inner wall, effectively sheltering sun or wind from coming in there-through as well as increasing the overall beauty of the door/window Venetian blind thereof in display.

It is, therefore, the secondary purpose of the present invention to provide a coupling structure for side bracket of door/window Venetian blind wherein the flat elastic plate clamped tight between the coupling board and the inner wall of the preset frame can fill up any fissures in case of rough surface on the inner wall thereof without any other silicon filling materials required, greatly simplifying the process of production and assembly as well as saving the costs of materials and production.

### BRIEF DESCRIPTION OF THE DRAWINGS

FIG. 1 is a sectional view of a conventional coupling structure for side bracket of door/window Venetian blind in assembly.

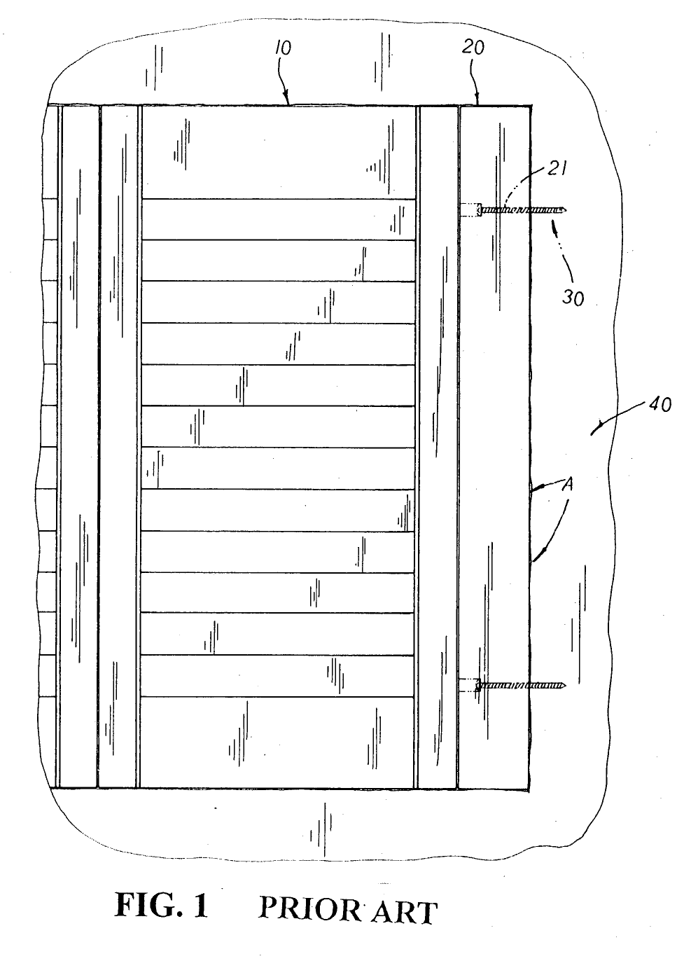

FIG. 2 is a perspective exploded view of the present invention.

FIG. 3 is a sectional view of the present invention in assembly.

### DETAILED DESCRIPTION OF THE PREFERRED EMBODIMENTS

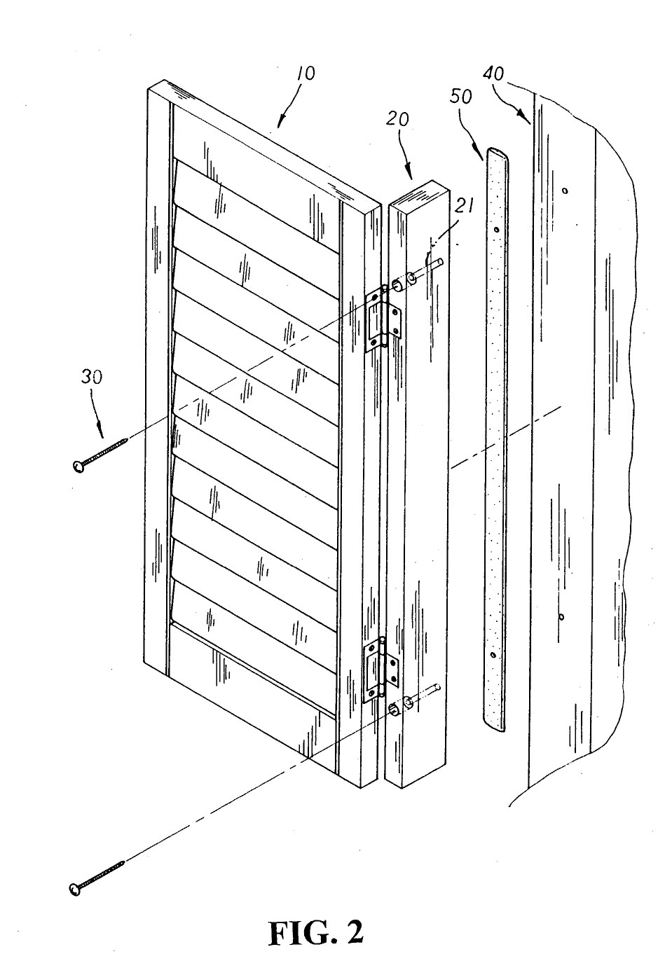

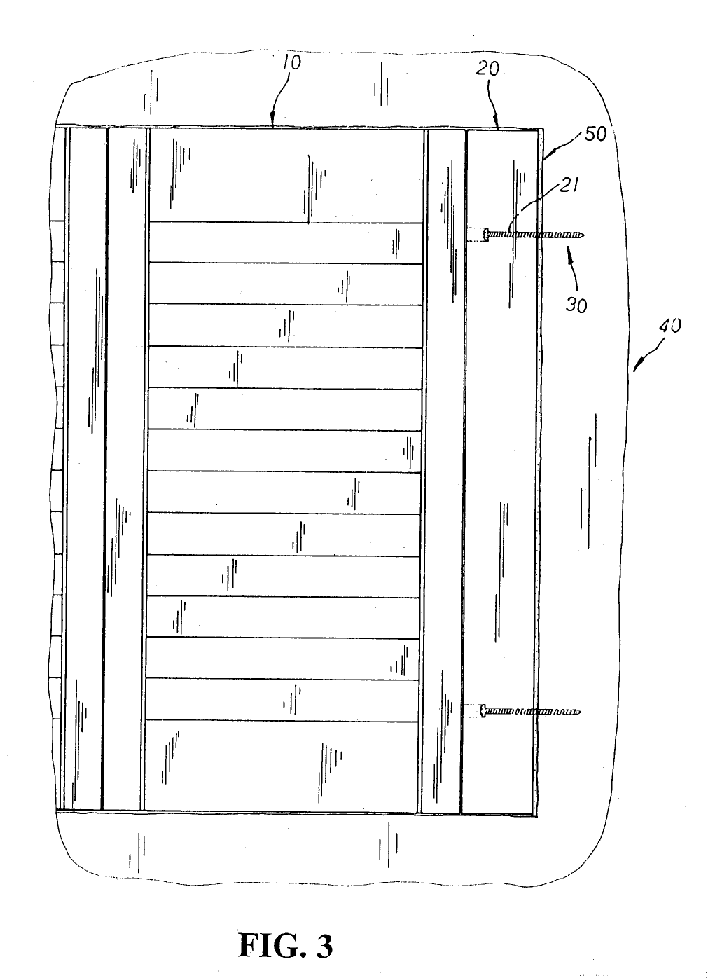

Please refer to FIGS. 2, 3. The present invention is related to a coupling structure for side bracket of door/window Venetian blind, mainly made up of a Venetian door/window unit 10, and a coupling board 20 pivotally joined to one side of the Venetian door/window unit 20. The other side of the coupling board 20 is provided with a plurality of equally spaced stepwise through holes 21 to which screws are adapted to lock the coupling board 20 thereof securely onto an inner wall 40 of a preset frame. A flat elastic plate 50 made of either plastic or soft foam materials is adapted to the space between the coupling board 20 and the inner wall 40 of the preset frame and sandwiched therein. When the coupling board 20 thereof is screw joined to the inner wall 40 thereof, the flat elastic plate 50 clamped tight there-between will fill up any fissures in case of rough surface on the inner wall 40 thereof, effectively sheltering sun or wind from coming in there-through as well as increasing the overall beauty of the door/window Venetian thereof in display. Thus, via the flat elastic plate 50, the coupling structure of the present invention is easily and conveniently mounted onto a preset frame without any other silicon filling materials required.

1-2. (Canceled)

3. A bracket for securing a frame of a window treatment to a wall comprising:
a) a coupling board pivotally connected at a first side to the frame of the window treatment;
b) at least one screw fixedly connecting a second side of the coupling board to the wall; and
c) an elastic plate connected to the wall by the at least one screw, the elastic plate being adjustably pressed between the coupling board and the wall to fill irregularities between surfaces of the second side of the coupling board and the wall.

4. The bracket according to claim 3, wherein the elastic plate is made of a material selected from a group consisting of a plastic and a soft foam.
